(19) United States
(12) Patent Application Publication
(10) Pub. No.: US 2026/0077622 A1
(43) Pub. Date: Mar. 19, 2026

(54) HITCH ASSEMBLY

(71) Applicant: B & W Custom Truck Beds, Inc., Humboldt, KS (US)

(72) Inventors: Travis M. McCall, Humboldt, KS (US); Shayla K. Stephens, Humboldt, KS (US)

(73) Assignee: B & W Custom Truck Beds, Inc., Humboldt, KS (US)

(21) Appl. No.: 19/280,531

(22) Filed: Jul. 25, 2025

Related U.S. Application Data
(60) Provisional application No. 63/695,762, filed on Sep. 17, 2024.

(51) Int. Cl. B60D 1/04; B60D 1/06; B60D 1/07; B60D 1/44

(52) U.S. Cl. CPC B60D 1/04; B60D 1/06; B60D 1/07; B60D 1/44; B60D 1/46

(57) ABSTRACT

A pintle hitch assembly includes a hitch member assembly comprising at least two hitch members projecting transverse to and radially outward from a shaft. A hitch member bearing rotatably supports the shaft of the hitch member assembly and is connected to a hitch member bearing mount that is adjustably securable to a draw bar assembly. A collar is secured to the hitch member bearing, and the shaft extends rearward through the collar and between the hitch member bearing and the hitch member assembly. A locking arm is rotatably secured to the hitch member bearing mount and is rotatable from a closed position, which is configured for locking the towing ring in an opening formed between the collar, the hitch member assembly, and the locking arm, to an open position.

### CROSS REFERENCE TO RELATED APPLICATION

This application claims the benefit of U.S. Provisional Patent Application No. 63/695,762 filed Sep. 17, 2024, the disclosure of which is hereby incorporated herein in its entirety by reference.

### BACKGROUND OF THE INVENTION

### Field of the Invention

The present invention relates generally to a hitch assembly, and more specifically, to a pintle hitch assembly.

### Background

A trailer hitch is mounted on a towing vehicle for engaging a coupler connected to a trailer or towed vehicle. A pintle hitch is a type of trailer hitch that engages a towing ring. Pintle hitches may be used in circumstances that require a greater range of movement than a ball hitch and/or require heavy-duty towing capabilities, such as in agricultural, military, and industrial settings. Pintle-ball hitches are combination hitches that allow the hitch to be used with a towing ring and with a ball hitch coupler that has lighter-duty towing capabilities. Pintle-ball hitches provide a convenient form that eliminates the need to switch hitches.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

The embodiments described herein relate to a pintle hitch assembly for engaging a towing ring. The pintle hitch assembly includes a draw bar assembly, a mount securable to the draw bar, a hitch member assembly secured to the mount, a locking arm, and a collar. The draw bar assembly includes a draw bar coupled to a distal end of a shank configured to be securable to a towing vehicle. The mount includes a hitch member bearing. The hitch member assembly includes a shaft extending from the hitch member bearing and one or more hitch members. A selected hitch member of the one or more hitch members is positionable to extend in an upward orientation. The locking arm is pivotably coupled to the mount and pivotable from an open position to a closed position. In the closed position, the locking arm extends adjacent to or in engagement with the selected hitch member positioned to extend in the upward orientation to secure the towing ring in an opening formed at least partially by the selected hitch member and the locking arm in the closed position. A lower surface of the locking arm is formed with a curved surface. The collar includes a concave portion and extends around the shaft of the hitch member assembly. The collar is coupled to the hitch member bearing and positioned between the hitch member bearing and the one or more hitch members. The opening is formed, at least partially, by the selected hitch member positioned to extend in the upward orientation, the lower surface of the locking arm in the closed position, and the concave portion of the collar extending around the shaft of the hitch member assembly. The opening is configured to at least partially correspond to an outer surface of the towing ring positioned therein and adjacent to the locking arm in the closed position to minimize movement of the towing ring secured in the opening.

In an embodiment described herein, the mount is adjustably securable to the draw bar to selectively position the hitch member assembly relative to the draw bar.

In an embodiment described herein, the mount is releasably securable to the draw bar in a selected one of a use position and a storage position. In an embodiment, the draw bar assembly includes a gusset extending between the draw bar and the shank and the locking arm includes a groove formed in a proximal end thereof, such that when the mount is secured to the draw bar in the storage position, a portion of the gusset extends through the groove without engaging the locking arm. In an embodiment, an upper surface of the locking arm includes a textured surface such that when the mount is in the use position and the locking arm is in the closed position, the upper surface of the locking arm is a support surface.

In an embodiment described herein, the selected hitch member positioned to extend in the upward orientation engages a distal end of the locking arm in the closed position to secure the towing ring in the opening. The distal end of the locking arm may be formed with a contour that is complimentary to an upper surface of the selected hitch member positioned to extend in the upward orientation.

In an embodiment described herein, at least one tab extends into engagement with one or more notches formed in the collar to prevent the collar from rotating.

The embodiments described herein relate to a pintle hitch assembly for engaging a towing ring. The pintle hitch assembly includes a draw bar assembly, a mount securable to the draw bar, a hitch member assembly secured to the mount, a locking arm, a collar, and an opening. The draw bar assembly includes a draw bar coupled to a distal end of a shank configured to be securable to a towing vehicle. The mount includes a hitch member bearing. The hitch member assembly includes a shaft extending from the hitch member bearing and a plurality of hitch members. A selected hitch member of the plurality of hitch members is positionable to extend in an upward orientation. The locking arm is pivotable from an open position to a closed position. The locking arm has a lower surface formed with a curved surface and a distal end formed with a contour that is complimentary to an upper surface of the selected hitch member positioned to extend in the upward orientation. The collar includes a concave portion and extends around the shaft of the hitch member assembly. The opening is configured to at least partially correspond to an outer surface of the towing ring to minimize movement of the towing ring secured therein. The opening is formed, at least partially, by the selected hitch member positioned to extend in the upward orientation, the curved surface of the locking arm in the closed position, and the concave portion of the collar extending around the shaft of the hitch member assembly. The distal end of the locking arm engages the selected hitch member to position the curved surface of the locking arm adjacent to the opening or corresponding to the outer surface of the towing ring.

In an embodiment described herein, the mount is adjustably securable to the draw bar to selectively position the hitch member assembly relative to the draw bar.

In an embodiment described herein, the mount is releasably securable to the draw bar in a selected one of a use position and a storage position. In an embodiment, the draw bar assembly includes a gusset extending between the draw bar and the shank and the locking arm includes a groove formed in a proximal end thereof, such that when the mount is secured to the draw bar in the storage position, a portion of the gusset extends through the groove without engaging the locking arm. In an embodiment, an upper surface of the locking arm includes a textured surface such that when the mount is in the use position and the locking arm is in the closed position, the upper surface of the locking arm is a support surface.

In an embodiment described herein, at least one tab extends into engagement with one or more notches formed in the collar to prevent the collar from rotating.

The embodiments described herein relate to a pintle hitch assembly for engaging a towing ring. The pintle hitch assembly includes a draw bar assembly, a mount releasably securable to the draw bar, a hitch member assembly secured to the mount, and a locking arm. The draw bar assembly includes a draw bar coupled to a distal end of a shank configured to be securable to a towing vehicle. The draw bar assembly includes a gusset extending between the draw bar and the shank. The mount is releasably securable to the draw bar in a selected one of a use position and a storage position. The hitch member assembly is secured to the mount and includes one or more hitch members. A selected hitch member of the one or more hitch members is positionable to extend in an upward orientation. The locking arm is pivotably coupled to the mount and pivotable from an open position to a closed position. In the closed position, the locking arm extends adjacent to or in engagement with the selected hitch member positioned to extend in the upward orientation to secure the towing ring in an opening formed at least partially by the selected hitch member and the locking arm in the closed position. The locking arm has a groove formed in a proximal end thereof and a lower surface formed with a curved surface. When the mount is secured to the draw bar in the storage position, a portion of the gusset extends through the groove without engaging the locking arm. When the mount is secured to the draw bar in the use position, the opening formed at least partially by the selected hitch member and the lower surface of the locking arm in the closed position is configured to at least partially correspond to an outer surface of the towing ring positioned therein and adjacent to the locking arm in the closed position to minimize movement of the towing ring secured in the opening.

In an embodiment described herein, the mount is adjustably securable to the draw bar to selectively position the hitch member assembly relative to the draw bar.

In an embodiment described herein, an upper surface of the locking arm includes a textured surface such that when the mount is in the use position and the locking arm is in the closed position, the upper surface of the locking arm is a support surface.

In an embodiment described herein, the mount further includes a hitch member bearing that rotatably secures a shaft extending from the hitch member assembly. The hitch member assembly is rotatable to position the selected hitch member in the upward orientation to engage a distal end of the locking arm in the closed position to secure the towing ring in the opening. In an embodiment, the distal end of the locking arm is formed with a contour that is complimentary to an upper surface of the selected hitch member in the upward orientation.

In an embodiment described herein, the pintle hitch assembly further includes a collar extending around a shaft of the hitch member assembly. A concave portion of the collar may form a portion of the opening. In an embodiment, the pintle hitch assembly further includes a hitch member bearing that rotatably secures the shaft of the hitch member assembly to position the selected hitch member in the upward orientation. The shaft extends rearward from the hitch member bearing, and the collar is coupled to the hitch member bearing and positioned between the hitch member bearing and the one or more hitch members.

### BRIEF DESCRIPTION OF THE DRAWING FIGURES

Embodiments of the invention are described in detail below with reference to the attached drawing figures.

FIG. 1 is a rear and side perspective view of an embodiment of a hitch assembly showing a pintle hitch in a use position with a locking arm in a closed position.

FIG. 2 is a front and side perspective view of the embodiment of the hitch assembly shown in FIG. 1.

FIG. 3 is a rear elevational view of the embodiment of the hitch assembly shown in FIG. 1.

FIG. 4 is a cross-sectional view taken through line 4-4 of the embodiment of the hitch assembly shown in FIG. 3.

FIG. 5 is a side elevational view of the embodiment of the hitch assembly shown in FIG. 1, but with the locking arm rotated into an open position and a support member removed to show a shaft of the ball mount assembly extending through a hitch member bearing that is configured to be secured to the support members.

FIG. 6 is a top plan view of the embodiment of the hitch assembly shown in FIG. 1.

FIG. 7 is a side elevational view of the embodiment of the hitch assembly shown in FIG. 1, but with the pintle hitch secured to the draw bar under the shank in a storage position and a support member removed to show a gusset that extends through a groove formed between hinge ears of the locking arm.

FIG. 8 is a perspective view of the pintle hitch shown in the embodiment of FIG. 1, showing the groove between the hinge ears and securement pins extending between the support members that are configured for securement to the draw bar.

FIG. 9 is a perspective view of the hitch assembly shown in FIG. 1, with a towing ring extending through an opening of the hitch assembly and the opening having a contoured surface approximately corresponding to an outer surface of the towing ring.

FIG. 10 is a cross-sectional view taken through line 10-10 of the embodiment of the pintle hitch and the towing ring shown in FIG. 9.

FIG. 11 is a perspective view of the pintle hitch shown in the embodiment in FIG. 1, with the ball mount assembly removed from the pintle hitch to show a collar coupled to the hitch member bearing that is configured to support the ball mount assembly.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

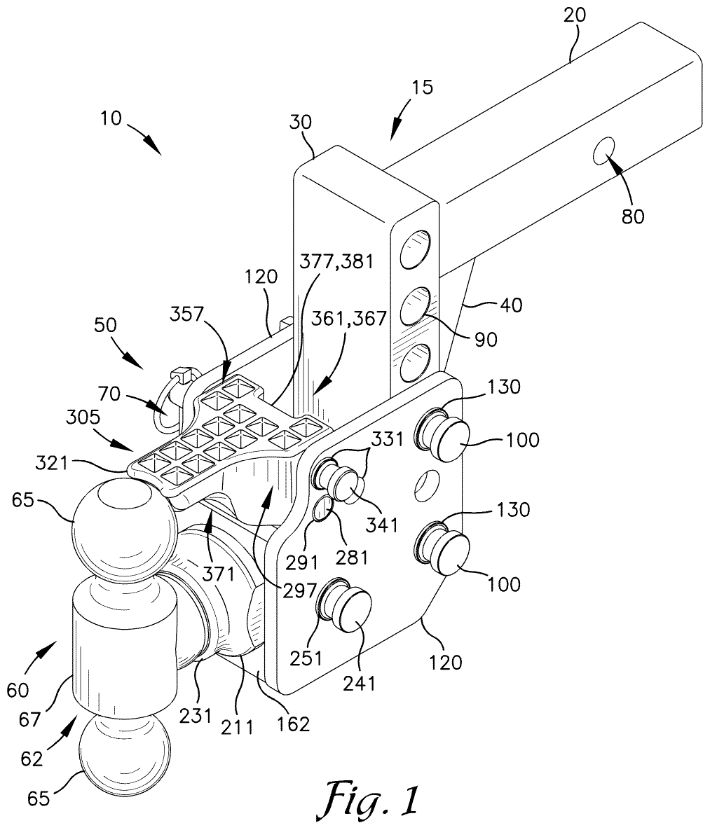

As used herein, directional references may be used with reference to the orientation of the vehicle to which a hitch assembly 10 is configured to be secured with the hitch assembly 10 being in a use position in which a coupler of a trailer or towed vehicle is able to engage the hitch assembly 10. With reference to FIG. 1, a “front” or “forward” portion of the hitch assembly 10 is to the right of the page and a “rear” or “rearward” portion of the hitch assembly 10 is to the left of the page. Similarly, a “top” or “upper” portion of the hitch assembly 10 extends toward the top of the page, and a “bottom” or “lower” portion extends toward the bottom of the page. The words “inwardly” and “outwardly” refer to directions toward and away from, respectively, a geometric center of an embodiment being described and designated parts thereof. Said terminology will include the words specifically mentioned, derivatives thereof, and words of a similar import. As used herein the words secure or secured or connect or connected or coupled, or variations thereof, include parts or components that are both formed separately and joined together as by welding or through a mechanical coupling or parts or components that are integrally formed together herein.

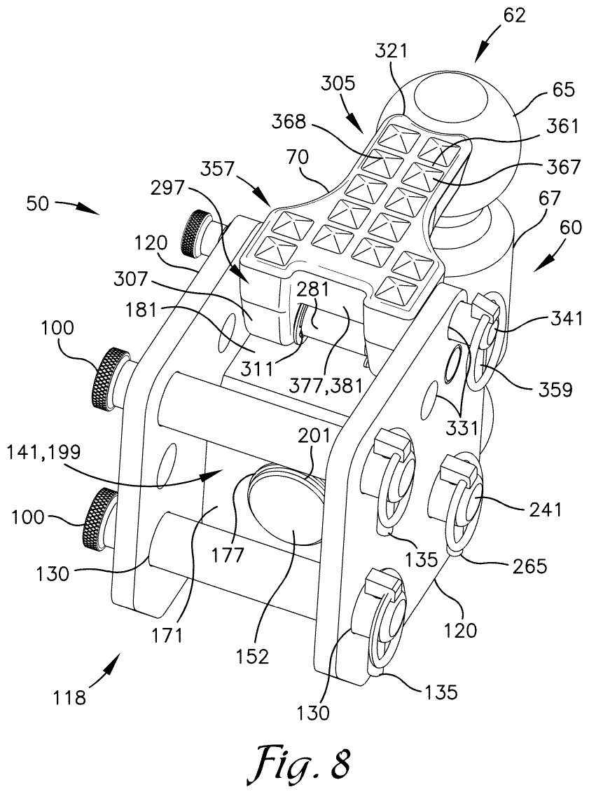

An embodiment of a hitch assembly 10 is shown in FIGS. 1-11. The hitch assembly 10 may also be referred to as a pintle hitch assembly 10. The hitch assembly 10 is an improvement over a stowable-lock, convertible-pintle hitch disclosed in U.S. Pat. No. 6,789,815 assigned to B&W Custom Truck Beds, Inc., of Humboldt, Kansas (the “815 patent”), which is incorporated by reference herein and discloses an apparatus having a hitch that may be a ball hitch, a pintle hitch, a pintle shaft, or any other type of hitch as shown and described therein suitable for serving as an attachment point for a trailer or other towed vehicle. FIGS. 1-7 show views of the hitch assembly 10, including a draw bar assembly or a hitch base 15 comprising a shank 20 secured to a draw bar 30 with a gusset 40 extending therebetween and a pintle hitch or pintle-ball hitch 50 adjustably coupled to or mounted to the draw bar 30. The draw bar 30 may also be referred to as a pin block 30. FIG. 8 shows an embodiment of the pintle hitch 50.

The pintle hitch 50 includes a ball mount assembly 60 configured to engage a coupler of a trailer or towed vehicle (not shown). The ball mount assembly 60 may also be referred to herein as a pintle hook and hitch ball assembly or a hitch member assembly 60. The ball mount assembly 60 includes a hitch ball assembly 62 comprising two or more hitch balls or hitch members 65 projecting radially outward from a hitch ball assembly shaft 67 and may include two, three or four hitch balls or hitch members of different sizes or shapes for connection to different sized or styles of trailer couplers. It is foreseeable that one or more of the hitch members could be replaced with a pintle shaft or hitch 26a shown in FIG. 15 of the '815 patent referenced herein. In an embodiment the ball mount assembly 60 or the hitch ball assembly 62 or one or more of the hitch members 65 may be treated with heat to improve wear performance, wear resistance and/or other properties of the metal. In the embodiment shown, the hitch ball assembly 62 includes two hitch balls 65 extending in axial alignment and in opposite directions. It is also foreseen that a third and/or a fourth hitch ball or hitch member could be mounted to extend transverse to the hitch balls 65 shown. The ball mount assembly 60 is selectively positionable such that each of the hitch balls 65 is selectively positionable to extend upward.

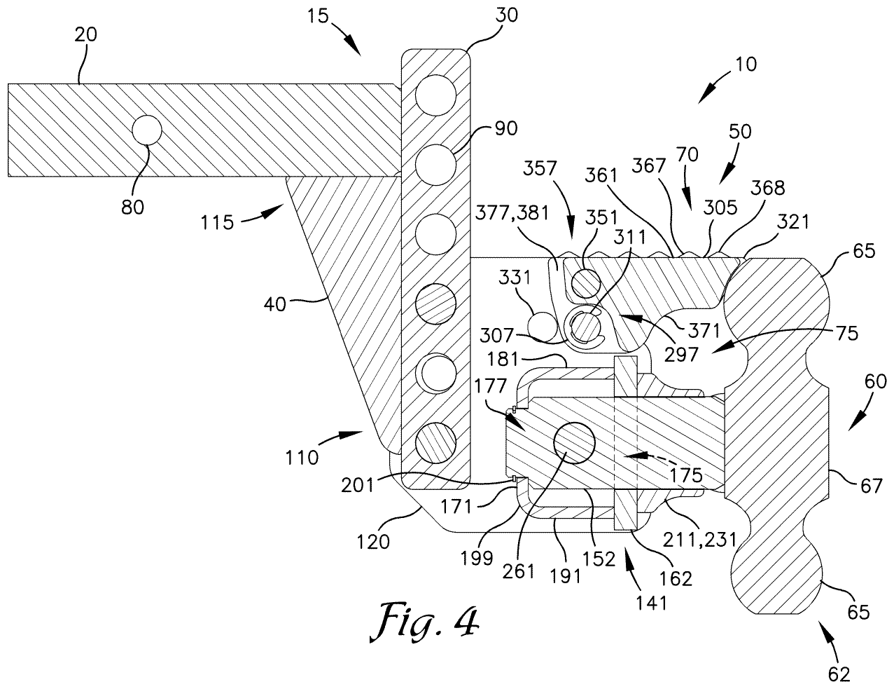

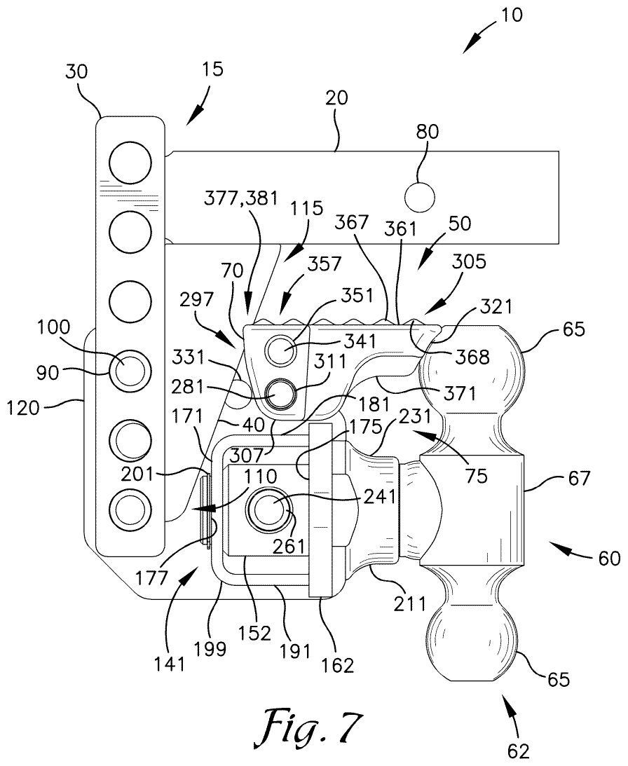

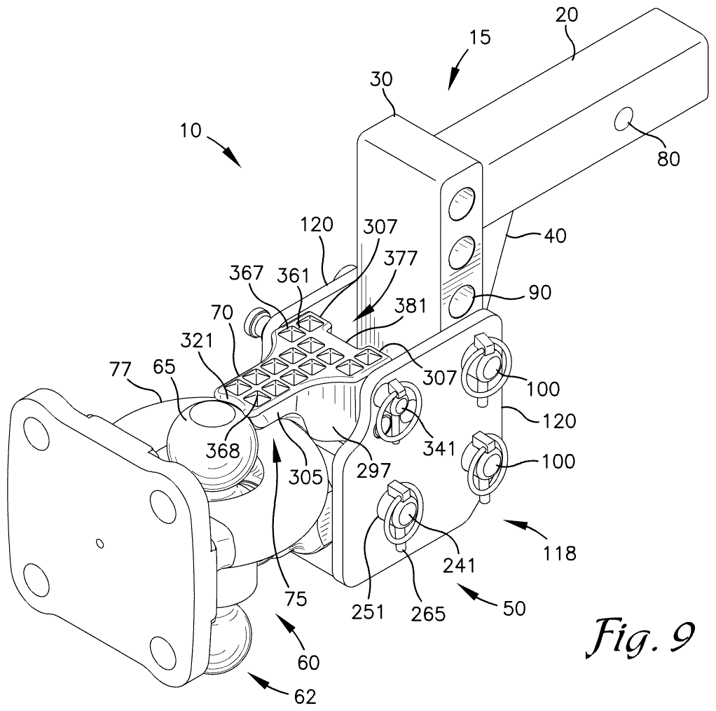

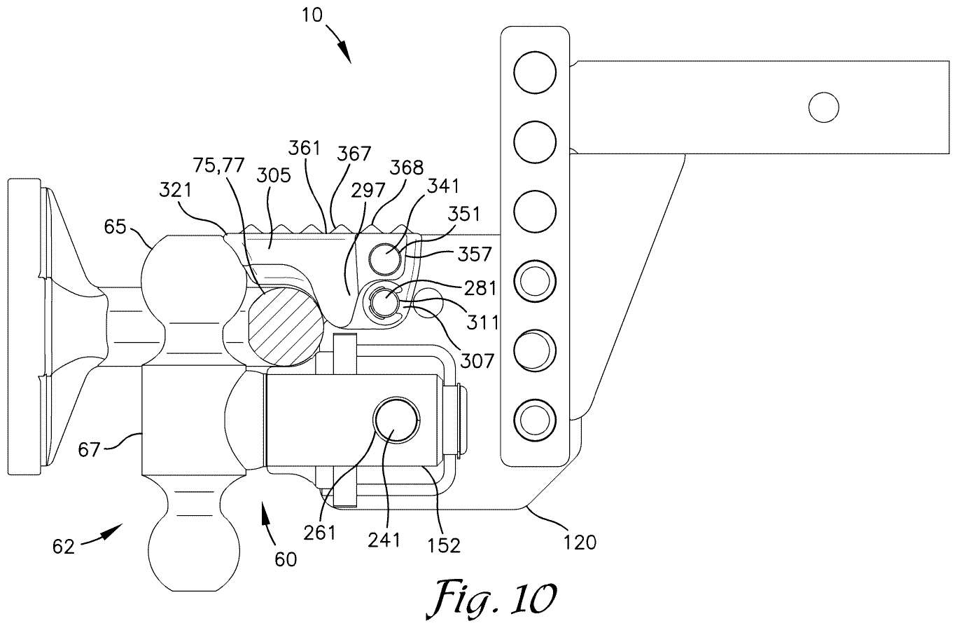

The ball mount assembly 60 shown also includes a pintle hook or locking arm 70. The hitch ball assembly 62 and the pintle hook or locking arm 70 cooperate to form an opening 75, shown in FIGS. 4 and 7, for advancement onto and receipt and securement of a portion of a coupler, such as, for example, a towing ring 77 that is connected to the trailer or towed vehicle. FIGS. 9 and 10 show the towing ring 77 extending through the opening 75. The ball mount assembly 60 is also configured to be engageable with a coupler that is securable to the hitch ball 65 of the ball mount assembly 60. It is foreseeable that the ball mount assembly 60 may be removable from the pintle hitch 50 such that accessories with different functions or different mounting structures may be secured to the pintle hitch 50 instead of the ball mount assembly 60.

The draw bar assembly 15 extends from and is configured to be securable to a towing vehicle (not shown) to secure the pintle hitch 50 to the towing vehicle. The draw bar assembly 15 comprises the shank 20 that is formed with a pin receiving opening 80 for receiving a hitch pin (not shown) to secure the draw bar assembly 15 to a hitch receiver of the towing vehicle. The shank 20 with the opening 80 and the hitch pin may be referred to as a securement mechanism. It is foreseeable that other types of securement mechanisms than those described herein may be used to secure the draw bar assembly 15 or the pintle hitch 50 to the towing vehicle, such as, for example, a mounting plate that is securable to the towing vehicle.

In an embodiment, the draw bar assembly 15 comprises the draw bar 30 that is connected to and extends perpendicular to a distal end of the shank 20. In the embodiment shown, the draw bar 30 is formed from a rectangular metal block with a plurality of holes 90 extending laterally or horizontally therethrough that are in vertical alignment with each other. Each of the plurality of holes 90 is configured to receive a securement pin 100 to secure the pintle hitch 50 to the draw bar 30 of the draw bar assembly 15. The plurality of holes 90 in the draw bar 30 allow the hitch ball 65 of the ball mount assembly 60 to be vertically adjustable relative to the draw bar 30.

In an embodiment, the gusset 40 is connected to the shank 20 and the draw bar 30 to reinforce the connection and the perpendicular angle between the shank 20 and the draw bar 30. The gusset 40 helps enable the draw bar 30 to resist horizontal forces applied to the hitch ball 65 of the ball mount assembly 60. As shown in FIG. 4, the gusset 40 may be formed to have a narrower dimension at a lower portion 110 thereof relative to an upper portion 115 to allow the pintle hitch 50, including the ball mount assembly 60, to be stored under the shank 20, as shown in FIG. 7, without the pintle hitch 50 engaging the gusset 40. In an embodiment, the gusset 40 has a triangular shape to connect the gusset 40 to the shank 20, to provide reinforcement or support along a length or longitudinal dimension of the draw bar 30, and to allow storage of the pintle hitch 50 under the shank 20, such as when the hitch assembly 10 is not in use. Alternatively, the gusset may be formed as a reinforcing rod or bar that that extends from the shank 20 to the draw bar 30.

The pintle hitch 50 is shown separated from the draw bar assembly 15 in FIG. 8 and includes a hitch member bearing mount 118 comprising two mounting flanges or support members 120 with pin securement holes 130 extending therethrough for use in adjustably securing the pintle hitch 50 to the draw bar 30. The two mounting flanges 120 are connected to a hitch ball bearing assembly 141 and project forward from opposite sides thereof, and the support members 120 are securable to the draw bar 30 of the draw bar assembly 15. One mounting flange 120 extends on each side of the pintle hitch 50 to engage the draw bar 30 on each side thereof. In an embodiment, the mounting flanges 120 are in the form of two plates securable to opposite outer surfaces of the draw bar 30 and allow vertical adjustment of the pintle hitch 50 relative to the draw bar 30 such that the ball mount assembly 60 is selectively positionable at different heights for engagement with the coupler of the trailer or towed vehicle. Each mounting flange 120 includes one or more securement holes 130, and preferably at least two securement holes 130 that are vertically spaced apart and alignable with the holes 90 extending through the draw bar 30. A securement pin 100 is insertable through a hole 90 of the draw bar 30 and the securement holes 130 of the mounting flanges 120 in alignment therewith to secure the pintle hitch 50 to the draw bar assembly 15. A lynch pin 135 or other locking means, such as a cotter pin or the like, may be used to secure each securement pin 100 in the hole 90 of the draw bar 30 and the securement holes 130 of the support members 120. In a preferred embodiment, the pintle hitch 50 is secured to the draw bar 30 by securement pins 100 extending through at least two holes 90 of the draw bar 30 and the securement holes 130 of the support members 120 that are in alignment with the two holes 90.

A hitch member bearing or hitch ball bearing assembly 141 is secured between the support members 120 and is configured to receive and rotatably support a shaft 152 coupled to the hitch ball assembly 62 for securing the ball mount assembly 60 thereto with one of the hitch balls 65 extending upward. In an embodiment, the ball mount assembly 60 comprises the shaft 152 that is secured to and extends transverse to the hitch ball assembly shaft 67. In an embodiment, the hitch ball assembly shaft 67 and the shaft 152 are connected and may be referred to as the shaft 152 and the hitch balls 65 project transverse to and radially outward therefrom. One of the support members 120 is secured to each side of the hitch ball bearing assembly 141, and the bearing assembly 141 supports the support members 120 in parallel, spaced relationship, with the securement holes 130 of the two support members 120 extending in axial alignment.

In the embodiment shown, the hitch ball bearing assembly 141 comprises spaced apart bearing plates 162 and 171, each with a respective shaft receiving opening or hole 175 and 177 extending therethrough sized to receive the shaft 152, which is secured to the hitch ball assembly 62 and rotatably supported by the bearing plates 162 and 171. Bearing plate 171 of the embodiment shown, and which may also be referred to as the first or forward bearing plate 171, is formed as a web interconnecting upper and lower legs 181 and 191 of a U-shaped bracket or support 199. Bearing plate 162, which may also be referred to as the second or rear bearing plate 162, is mounted to extend across the distal ends of legs 181 and 191 opposite the first bearing plate 171. Second bearing plate 162 extends vertically in rearward spaced relation from the first bearing plate 171. It is foreseen that the hitch ball bearing assembly 141 may be formed as a bearing block or another bearing structure that rotatably supports the shaft 152 and includes a surface configured for securing and/or supporting a bearing collar as described herein.

A retaining ring 201 is secured around a distal end of the shaft 152 forward of the first bearing plate 171 and prevents the shaft 152 from being pulled out of the openings 175 and 177 in the respective first and second bearing plates 171 and 162 of the hitch ball bearing assembly 141. The shaft 152 extends rearward from the rear bearing plate 162 a distance sufficient for receipt of a forward segment of a tow ring 77 secured over an upwardly oriented one of the hitch balls 65 between the hitch ball 65 and the rear bearing plate 162.

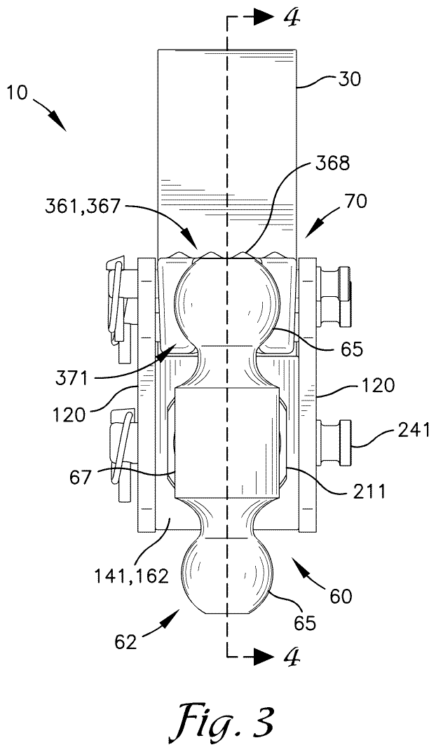

A bearing collar or collar 211 is positioned around the portion of the shaft 152 extending rearward from the hitch ball bearing assembly 141 and between the rear bearing plate 162 and the hitch ball assembly 62. A forward end or face of the bearing collar 211 is positioned against and engages or abuts an outward or hitch-ball facing surface of the plate 162. The collar 211 may be treated with heat to improve wear performance, wear resistance, and/or other properties thereof. The collar 211 is formed with a concave neck portion 231 that extends rearwardly or toward the ball mount assembly 60 from the plate 162 to create a rounded or curved surface in the opening 75 having a radius of curvature which generally matches or corresponds to a radius of curvature of a lower portion of the towing ring (see FIG. 10). As used herein, the term “corresponds to” means similarly shaped and sized. The collar 211, the hitch member 65 of the ball mount assembly 60, and the locking arm 70, in a closed position, cooperate to form the opening 75, which, between at least the collar 211 and locking arm 70, approximates a cross sectional shape and size of a portion of the towing ring to minimize movement and prevent unnecessary movement of the towing ring relative to the pintle hitch 50. In the embodiment shown, the portion of the opening 75 formed by the collar 211 and locking arm 70 generally conforms to the cross-sectional shape of the outer surface of the towing ring 77. As shown in FIGS. 1 and 3, a forward end of the collar 211 is sized and shaped such that it does not extend laterally beyond the inner faces of the support members 120.

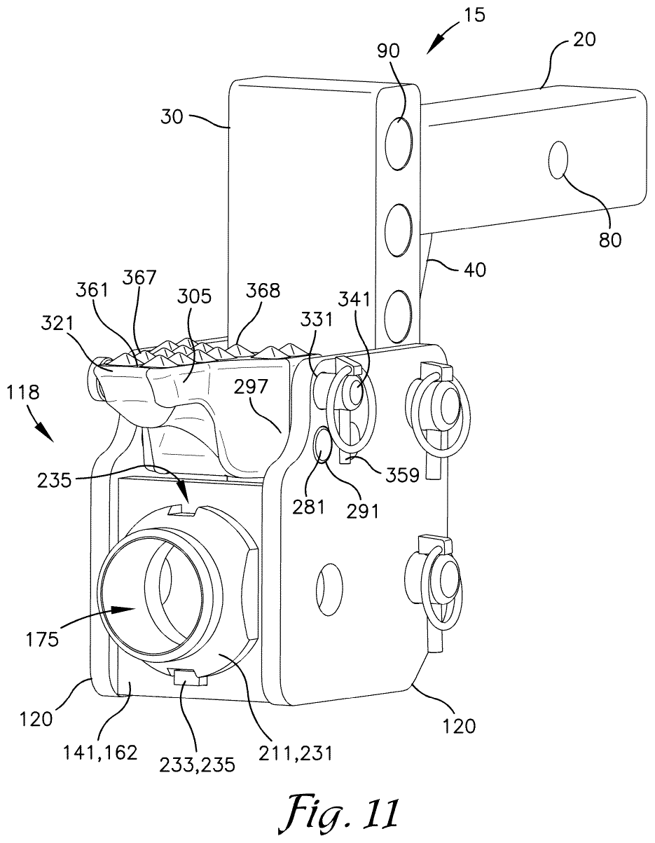

In an embodiment shown in FIG. 11, a tab 233 formed on the lower leg 191 extends through the rear bearing plate 162 to engage a lower or bottom one of two notches or locking elements 235 formed in the collar 211 on opposite sides thereof. It is foreseen that the collar 211 may include one notch 235 or may include one or more notches 235 that are configured to engage a tab 233 to prevent the collar 211 from rotating relative to the shaft 152. In an embodiment, one or both of the upper leg 181 and the lower leg 191 may include a tab 233 formed thereon extending rearwardly therefrom through an opening in the rear bearing plate 162. It is foreseeable that a tab could be formed on the rear bearing plate 162 to engage the notches 235.

As shown in FIGS. 1-5 and 7-10, insertion of a securement pin 241 through aligned holes 251 in the support members 120 of the pintle hitch 50 and a hole 261 extending laterally through the shaft 152 prevents rotation of the ball mount assembly 60 relative to the hitch ball bearing assembly 141. In an embodiment that includes a hitch ball assembly 62 having a third and/or fourth hitch ball extending transverse to the hitch balls 65 shown, the shaft 152 may include a second hole (not shown) extending transverse to the hole 261 and/or transverse to an axis of the third and/or fourth hitch balls for preventing rotation of the ball mount assembly 60, similar to the turntable assembly 200 in FIG. 16 of the '815 patent referenced herein. A lynch pin 265 or other locking means, such as a cotter pin, may be used to secure the securement pin 241 in the holes 251 of the of the support members 120 and the hole 261 of the shaft 152.

The locking arm 70 is pivotably connected to the support members 120 of the hitch member bearing mount 118 and rotatable or pivotable about a hinge pin 281 and may be positioned in a closed position, an open position, or a position in between the closed position and the open position. The support members 120 each include a hole 291 through which the pin 281 extends for securing the locking arm 70 between the support members 120.

The locking arm 70 is formed with a hinge or clevis portion 297 and an arm portion 305. The hinge portion 297 extends below the arm portion 305, and the arm portion 305 projects rearward from the hinge portion 297 when the locking arm 70 is in the closed position. The hinge portion 297 includes a pair of hinge ears or tabs 307 projecting downward from and in spaced apart relation from the arm portion 305. The pivot pin 281 extends through pin receiving holes 291 formed in the support members 120 and through pivot pin receiving holes 311 formed in the hinge ears 307 of the locking arm 70 to allow pivoting of the locking arm 70 relative to the support members 120. The arm portion 305 is formed integral with the hinge portion 297. The arm portion 305 is sized such that a distal end 321 of the arm portion 305 of the locking arm 70 extends rearwardly relative to the hitch member bearing mount 118 and engages or extends in closely spaced relation with a vertically oriented hitch ball 65, which extends upward relative the hitch member bearing 141, when the locking arm 70 is in the closed position.

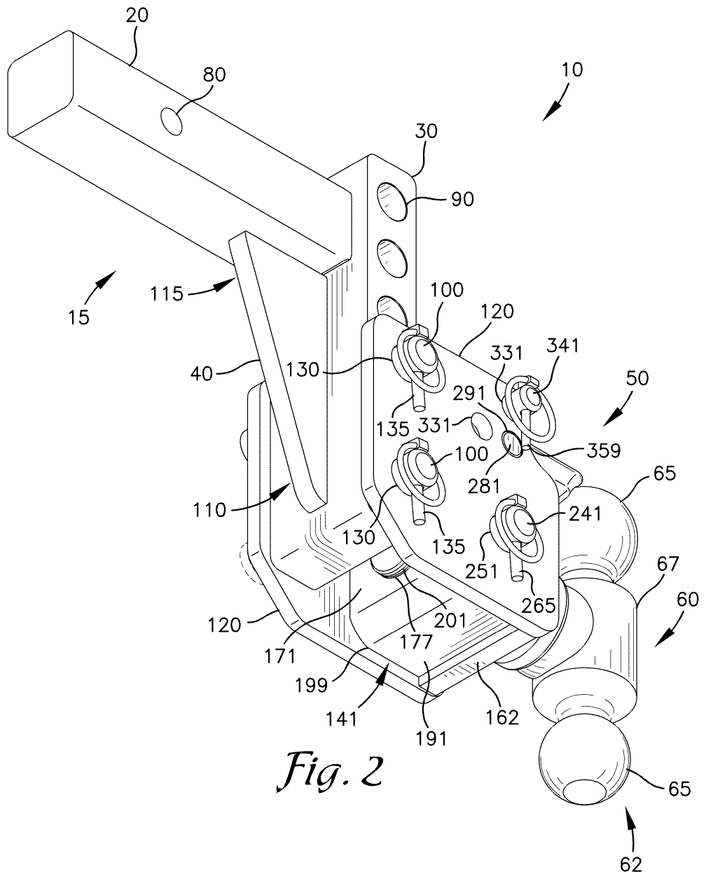

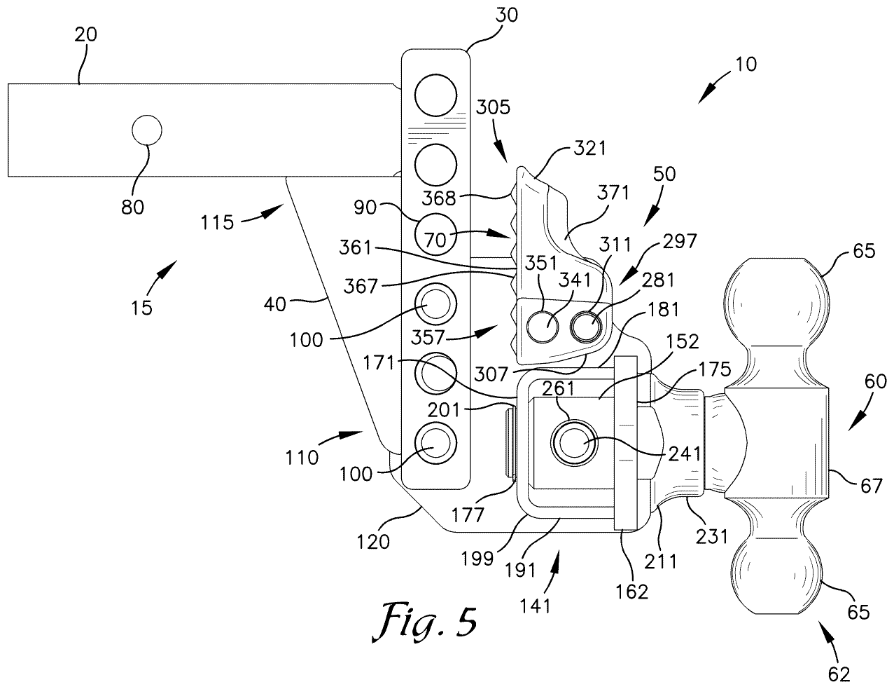

The locking arm 70 may be locked in the closed position or in the open position. The support members 120 include at least two sets of locking pin receiving holes 331 that are engageable by a securement pin 341 extendable through the holes 331 and through a securement hole 351 that extends through a pivot base body 357 of the locking arm 70. A lynch pin 359 or other locking means, such as a cotter pin, may be used to secure the securement pin 341 in the holes 331 and the securement hole 351 of the of the pivot base 357. As shown in FIG. 1, one of the holes 331 of each support member 120 is positioned above the hole 291 and is configured to secure the locking arm 70 in the closed position such that the securement hole 351 of the locking arm 70 is above the pin 281. In the closed position, the pintle hitch 50 is configured to lock a towing ring 77 within the opening 75. As shown in FIG. 2, one of the holes 331 of each support member 120 is positioned forward or away from the hitch ball assembly 62 relative to the hole 291 and is configured to secure locking arm 70 in the open position, as shown in FIG. 5, such that the securement hole 351 of the locking arm 70 is forward of the pin 281. In the open position, the locking arm 70 extends upward and the pintle hitch 50 is configured such that the towing ring 77 is advanceable onto or off of the hitch ball 65 or is configured to receive a coupler that is engageable with the hitch ball 65.

An upper surface 361 of the locking arm 70 is formed such that when the locking arm 70 is in the closed position, the upper surface 361 of the locking arm 70 is in a horizontal orientation and at approximately a same level as or above the support members 120 and/or a top of the hitch ball 65 as shown in FIGS. 3 and 4 and may be used as a support or a support surface, such as a step to step into a truck bed or a support for an object. The upper surface 361 may include a textured surface 367 that is configured to provide traction to prevent a user or object from slipping or moving on the upper surface 361 when the locking arm 70 is in the closed position. The textured surface 367 may be in the form of projections, such as bumps, divots, ribs, or other regular or irregular surface features that would be understood in the art to prevent slipping. In the embodiment shown, the textured surface 367 is formed by a plurality of square pyramidal projections 368 extending upward from the upper surface 361 of the locking arm 70 in the closed position. The locking arm 70 is supported in the closed position by the securement pin 341, the pin 281, and/or the distal end 321 of the arm portion 305 engaging a surface of the hitch ball 65. In an embodiment, the distal end 321 is formed with a curve or contour that is complimentary to and configured to engage an upwardly extending and curved side surface of the hitch ball 65 to prevent the locking arm 70 from rotating downward past the horizonal orientation.

Referring to FIGS. 1, 3 and 4, each of the hitch balls 65 in the embodiment shown has a flattened distal end forming a flattened upper surface, upper end or top 370 when the respective hitch ball 65 is positioned to extend upward. In the embodiment shown, a horizontal plane extending across the upper surface 361 of the locking arm 70 and at the base of each square pyramidal projection 368 extends across and in alignment with the flattened upper surface or top 370 of the upwardly extending hitch ball 65. The curved distal end 321 of the locking arm abuts against and rests on the upwardly extending, curved side surface of the hitch ball 65. In the embodiment shown, the upper surface 361 of the locking arm 70 in the closed position may be described as extending at the same or approximately the same level or in approximately the same plane as the upper surface or top 370 of the upwardly extending hitch ball 65. A plane extending through the upper surface 361 of the locking arm 70 may also be described as extending in closely spaced relation to a plane extending through an upper surface or top 370 of the upwardly extending hitch ball 65. The plane extending across the upper surface 361 of the locking arm 70 may also be described as extending in the same plane as the upper edge of the support members 120 or in closely spaced relation thereto.

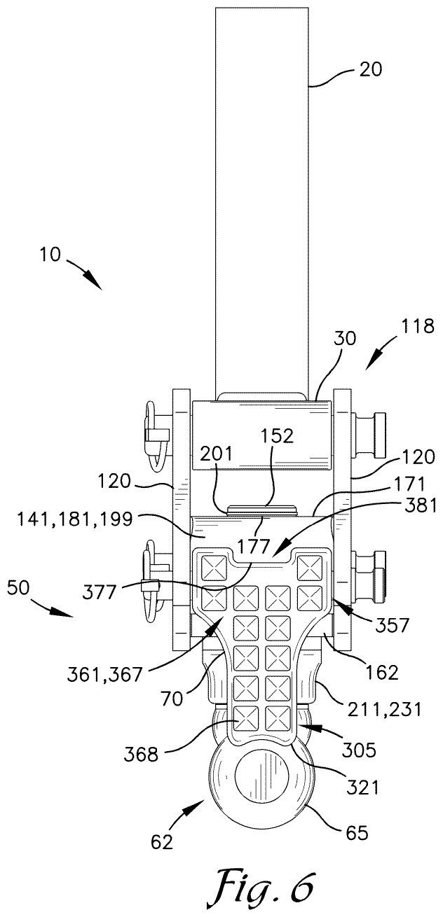

A lower surface 371 of the locking arm 70 adjacent to the opening 75 comprises a rounded or curved surface that is formed to fit the towing ring as described herein. Specifically, the pivot base 357 and the arm portion 305 are formed integrally and gradually narrow in a height dimension as shown in FIG. 4 and in a width dimension as shown in FIG. 6 from the ears 307 of the pivot base 357 toward the arm portion 305.

In an embodiment, the ears 307 of the pivot base 357 extend forward from the sides of a proximal end 377 of the arm portion 305 to form a groove or depression 381 between the tabs 307 as shown in FIGS. 6 and 8. The groove 381 enables the pintle hitch 50 to be disconnected from the draw bar 30 and reconnected under the shank 20 in a storage position such that the pintle hitch 50 does not engage the gusset 40, as shown in FIG. 7. The storage position of the pintle hitch 50 enables a user to store the pintle hitch 50 in a convenient position and location that does not interfere with activities around the towing vehicle but ensures that the hitch assembly 10 is always available if needed.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations and are contemplated within the scope of the claims.

What is claimed is:

1. A pintle hitch assembly for engaging a towing ring, the pintle hitch assembly comprising:
a draw bar assembly including a draw bar coupled to a distal end of a shank configured to be securable to a towing vehicle;
a mount securable to the draw bar and comprising a hitch member bearing;
a hitch member assembly comprising a shaft extending from the hitch member bearing and one or more hitch members, wherein a selected hitch member of the one or more hitch members is positionable to extend in an upward orientation;
a locking arm pivotably coupled to the mount and pivotable from an open position to a closed position, wherein in the closed position the locking arm extends adjacent to or in engagement with the selected hitch member positioned to extend in the upward orientation to secure the towing ring in an opening formed at least partially by the selected hitch member and the locking arm in the closed position, wherein a lower surface of the locking arm is formed with a curved surface;
a collar comprising a concave portion and extending around the shaft of the hitch member assembly, the collar coupled to the hitch member bearing and positioned between the hitch member bearing and the one or more hitch members; wherein:
the opening is formed at least partially by the selected hitch member positioned to extend in the upward orientation, the lower surface of the locking arm in the closed position, and the concave portion of the collar extending around the shaft of the hitch member assembly, and the opening is configured to at least partially correspond to an outer surface of the towing ring positioned therein and adjacent to the locking arm in the closed position to minimize movement of the towing ring secured in the opening.

2. The pintle hitch assembly of claim 1, wherein the mount is adjustably securable to the draw bar to selectively position the hitch member assembly relative to the draw bar.

3. The pintle hitch assembly of claim 1, wherein the mount is releasably securable to the draw bar in a selected one of a use position and a storage position.

4. The pintle hitch assembly of claim 3, wherein the draw bar assembly includes a gusset extending between the draw bar and the shank and the locking arm comprises a groove formed in a proximal end thereof, and when the mount is secured to the draw bar in the storage position, a portion of the gusset extends through the groove without engaging the locking arm.

5. The pintle hitch assembly of claim 3, wherein an upper surface of the locking arm includes a textured surface such that when the mount is in the use position and the locking arm is in the closed position, the upper surface of the locking arm is a support surface.

6. The pintle hitch assembly of claim 1, wherein the selected hitch member positioned to extend in the upward orientation engages a distal end of the locking arm in the closed position to secure the towing ring in the opening, wherein the distal end of the locking arm is formed with a contour that is complimentary to an upper surface of the selected hitch member positioned to extend in the upward orientation.

7. The pintle hitch assembly of claim 1, further comprising at least one tab extending into engagement with one or more notches formed in the collar to prevent the collar from rotating.

8. A pintle hitch assembly for engaging a towing ring, the pintle hitch assembly comprising:
a draw bar assembly including a draw bar coupled to a distal end of a shank configured to be securable to a towing vehicle;
a mount securable to the draw bar and comprising a hitch member bearing;
a hitch member assembly comprising a shaft extending from the hitch member bearing and a plurality of hitch members, wherein a selected hitch member of the plurality of hitch members is positionable to extend in an upward orientation;
a locking arm pivotable from an open position to a closed position, the locking arm having a lower surface formed with a curved surface and a distal end formed with a contour that is complimentary to an upper surface of the selected hitch member positioned to extend in the upward orientation;
a collar comprising a concave portion and extending around the shaft of the hitch member assembly;
an opening configured to at least partially correspond to an outer surface of the towing ring to minimize movement of the towing ring secured therein, the opening formed at least partially by the selected hitch member positioned to extend in the upward orientation, the curved surface of the locking arm in the closed position, and the concave portion of the collar extending around the shaft of the hitch member assembly; wherein:
the distal end of the locking arm engages the selected hitch member to position the curved surface of the locking arm adjacent to the opening.

9. The pintle hitch assembly of claim 8, wherein the mount is adjustably securable to the draw bar to selectively position the hitch member assembly relative to the draw bar.

10. The pintle hitch assembly of claim 8, wherein the mount is releasably securable to the draw bar in a selected one of a use position and a storage position.

11. The pintle hitch assembly of claim 10, wherein the draw bar assembly includes a gusset extending between the draw bar and the shank and the locking arm comprises a groove formed in a proximal end thereof, and when the mount is secured to the draw bar in the storage position, a portion of the gusset extends through the groove without engaging the locking arm.

12. The pintle hitch assembly of claim 10, wherein an upper surface of the locking arm includes a textured surface such that when the mount is in the use position and the locking arm is in the closed position, the upper surface of the locking arm is a support surface.

13. The pintle hitch assembly of claim 8, further comprising at least one tab extending into engagement with one or more notches formed in the collar to prevent the collar from rotating.

14. A pintle hitch assembly for engaging a towing ring, the pintle hitch assembly comprising:
a draw bar assembly including a draw bar coupled to a distal end of a shank configured to be securable to a towing vehicle, the draw bar assembly including a gusset extending between the draw bar and the shank;
a mount releasably securable to the draw bar in a selected one of a use position and a storage position;
a hitch member assembly secured to the mount and comprising one or more hitch members, a selected hitch member of the one or more hitch members positionable to extend in an upward orientation;
a locking arm pivotably coupled to the mount and pivotable from an open position to a closed position, wherein in the closed position the locking arm extends adjacent to or in engagement with the selected hitch member positioned to extend in the upward orientation to secure the towing ring in an opening formed at least partially by the selected hitch member and the locking arm in the closed position, the locking arm having a groove formed in a proximal end thereof and a lower surface formed with a curved surface; wherein:
when the mount is secured to the draw bar in the storage position, a portion of the gusset extends through the groove without engaging the locking arm, and
when the mount is secured to the draw bar in the use position, the opening formed at least partially by the selected hitch member and the lower surface of the locking arm in the closed position is configured to at least partially correspond to an outer surface of the towing ring positioned therein and adjacent to the locking arm in the closed position to minimize movement of the towing ring secured in the opening.

15. The pintle hitch assembly of claim 14, wherein the mount is adjustably securable to the draw bar to selectively position the hitch member assembly relative to the draw bar.

16. The pintle hitch assembly of claim 14, wherein an upper surface of the locking arm includes a textured surface such that when the mount is in the use position and the locking arm is in the closed position, the upper surface of the locking arm is a support surface.

17. The pintle hitch assembly of claim 14, wherein the mount further comprises a hitch member bearing that rotatably secures a shaft extending from the hitch member assembly, wherein the hitch member assembly is rotatable to position the selected hitch member in the upward orientation to engage a distal end of the locking arm in the closed position to secure the towing ring in the opening.

18. The pintle hitch assembly of claim 17, wherein the distal end of the locking arm is formed with a contour that is complimentary to an upper surface of the selected hitch member in the upward orientation.

19. The pintle hitch assembly of claim 14, further comprising a collar extending around a shaft of the hitch member assembly, wherein a concave portion of the collar forms a portion of the opening.

20. The pintle hitch assembly of claim 19, further comprising a hitch member bearing that rotatably secures the shaft of the hitch member assembly to position the selected hitch member in the upward orientation, wherein the shaft extends rearward from the hitch member bearing, and the collar is coupled to the hitch member bearing and positioned between the hitch member bearing and the one or more hitch members.
